(19) United States
(12) Patent Application Publication
(10) Pub. No.: US 2013/0112657 A1
(43) Pub. Date: May 9, 2013

(54) ARC CHAMBER ASSEMBLY FOR USE IN MOULDED CASE CIRCUIT BREAKERS

(71) Applicants: Nayan B. Degda, Powai (IN); Mukesh L. Nimani, Powai (IN); Amit Chaturvedi, Powai (IN)

(72) Inventors: Nayan B. Degda, Powai (IN); Mukesh L. Nimani, Powai (IN); Amit Chaturvedi, Powai (IN)

(73) Assignee: LARSEN & TOUBRO LIMITED, Maharashtra, Mumbai (IN)

(21) Appl. No.: 13/809,004

(22) PCT Filed: Jul. 6, 2011
(86) PCT No.: PCT/IB11/01573

§ 371 Date: Jan. 8, 2013

(30) Foreign Application Priority Data
Jul. 8, 2010 (IN) 1960/MUM/2010

(51) Int. Cl. H01H 33/02

(52) U.S. Cl. CPC H01H 33/02
USPC 218/157

(57) ABSTRACT

The present invention relates to an improved arc chamber/chute assembly in a circuit breaker for effective channelization of hot ionized gases through said arc chamber to enhance breaking capacity in circuit breakers. The assembly comprises back vent secured inside said arc chute assembly and front vent secured inside the assembly placed between the back vent and arc chute plates of the assembly. The front vent comprises a substantially T-shaped profile having a substantially horizontal portion along X-axis and a substantially vertical portion along Y-axis so as to define a substantially divergent nozzle profile in the said T-shaped profile such that at the time of high fault conditions in said arc chamber nozzle effect is generated due to high pressure build up in arc chamber assembly.

### FIELD OF THE INVENTION

The present invention relates to moulded case circuit breakers. Particularly, the invention relates to an improved arc chamber/chute assembly for use in moulded case circuit breakers. More particularly, the present invention relates to an improved arc chamber assembly comprising a unique venting construction for improved channelization of arc and hot gases effectively during high fault conditions thereby enhancing the breaking capacity of circuit breakers.

### BACKGROUND AND THE PRIOR ART

Electrical switching apparatus, such as circuit breakers, are employed in diverse capacities in power distribution systems such as, for example, to provide protection for electrical equipment from electrical fault conditions (e.g. without limitation, current overloads, short circuits, abnormal level voltage conditions). Therefore the short circuit capacity of any circuit breaker is totally governed by the performance of its arc quenching chamber.

The prior art circuit breakers consist of an arc chamber assembly which when subjected to a short circuit current of few kilo amperes quench the arc with long arcing times. The long arcing times lead to severe stresses on the downstream equipments due to large amount of let through energy. This is because of their inability to channelize the hot ionized gases effectively during high fault conditions. These arc chamber assemblies are inefficient in terms of total arcing time and let through energy with a circuit breaker passes to the downstream equipments.

The prior art arc chamber assemblies consist of perforated vents behind the arc chute assembly. These are inefficient in terms of pressure built up. Hence, these arc chamber assemblies are inefficient in terms of total arcing time and let through energy which a circuit breaker passes to the downstream equipments.

U.S. Pat. No. 4,405,846 discloses an arc chamber channel for providing cooling of an electric arc and quenching thereof for use with a circuit breaker includes an integral, generally U-shaped member which forms a base and opposing side walls. One end of the opposing side walls has extending tabs which are folded outwardly, providing a pair of point contacts for engaging side walls of a circuit breaker housing. An opposite end of the base is formed with an extending tab for engaging a molded feature of a side wall of the circuit breaker housing. Thus, all the extending tabs are adapted to space the channel away from the side walls of the circuit breaker, thereby exposing outer surfaces of the channel when in use in a circuit breaker. The base has an arrangement of venting holes therein. The tabs can be diagonally folded outwardly, and the channel can be formed of steel. An improved circuit breaker housing can include the channel, the housing further including a vent passage within the housing which is exterior to the channel. Molded projections in the housing are formed in a vent passage in proximity to the holes to provide cooling surfaces. The projections are spaced away from the holes sufficiently to provide passage of expulsive gases.

U.S. Pat. No. 4,639,564 discloses a circuit breaker with arc chamber vent characterized by a molded insulating housing containing circuit breaker means and an arc quenching chamber, the housing having wall means forming a compartment containing a terminal, and the wall means having gas vent opening communicating between the chamber and the compartment and a tubular wall surrounding the terminal for preventing any arc gases exhausting from the chamber into the compartment from causing electrical breakdown between the terminal and any proximate conductor.

U.S. Pat. No. 5,689,097 and U.S. Pat. No. 5,892,195 disclose an improved arc-resistant switchgear enclosure is disclosed. The disclosed arc-resistant switchgear enclosure provides a cost effective structure to collect and channel the pressure and hot exhaust gases from lower compartments and safely vent these gases through the switchgear enclosure. In preferred embodiments, an internal arc chamber is formed by assembling modules and creating a void within the center of the switchgear enclosure. As multiple compartments or modules for a switchgear enclosure are connected, an arc chamber is created within the enclosure. Upon initiation of an arc fault within a particular compartment, a relief flap or cover for that particular compartment opens to channel the pressure and the gases into the internal arc chamber or directly through the top of the enclosure. Pressure and gases are vented into the internal arc chamber and flow horizontally through the arc chamber until a path to the top of the switchgear enclosure is reached. These, pressures and hot gases are then channeled upward and safely out of the switchgear enclosure. Also disclosed is a ventilation system for an arc-resistant switchgear enclosure that provides natural ventilation while preventing any arc gases from entering the lower, ventilated compartment(s), and that permits proper venting of pressure arc gases if originated in the ventilated compartment(s).

U.S. Pat. No. 6,198,063 discloses a multi-phase circuit breaker assembly 10 includes a circuit breaker 12 having a housing 13 containing circuit breaker operating components and having a gas venting chamber 22 associated with each phase of the circuit breaker. The circuit breaker has a plurality of line wiring terminals 26 at a first end 14 of the housing. Each line wiring terminal corresponds to a phase of the circuit breaker. A terminal cover 30 is removably coupled to the first end of the housing so as to cover the line wiring terminals and prevent access to the line wiring terminals when coupled to the first end of the housing, and to gain access to the line wiring terminals only when removed from the first end of the housing. The terminal cover 30 includes a plurality of vent structures 38 integrally formed therewith. Each vent structure is in communication with an associated gas venting chamber and each vent structure is isolated from each other such that arc gases generated in each phase of the circuit breaker are exhausted through an associated vent structure with arc gases from one phase being prevented 1) from coming into contact with arc gases or line wiring terminals of a different phase, and 2) from coming into contact with wiring terminals of the same phase, thereby preventing a short circuit.

It was found that most of the prior art suffer from following disadvantages:
Inefficient channelization of hot gases during short circuit conditions
Lesser cooling of hot gases due to inefficient channelization
Long arcing times
Higher let through energy

Thus there is a need to provide for an improved arc chamber assembly comprising a unique venting construction for improved channelization of arc and hot gases effectively during high fault conditions thereby enhancing the breaking capacity of circuit breakers.

### OBJECTS OF THE INVENTION

The basic object of the present invention is to overcome the disadvantages of the prior art.

Another object of the present invention is to provide an improved arc chamber assembly with divergent vent for circuit breakers.

Yet another object of the present invention is to provide an improved arc chamber assembly adapted to enhance the circuit breakers breaking capacity by effective channelization of hot gasses inside the arc chamber.

Yet another object of the present invention is to provide an improved arc chamber assembly to provide unique venting arrangement that channelizes the gases such that significant cooling takes place.

Yet another object of the present invention is to provide an improved arc chamber assembly to provide short arcing times and reduces let through energy.

### SUMMARY OF THE INVENTION

According to one aspect of the present invention there is provided an improved arc chamber/chute assembly in a circuit breaker adapted for effective channelization of hot ionized gases through said arc chamber to enhance breaking capacity in circuit breakers, said assembly comprising:
(i) back vent secured inside said arc chute assembly of a conventional circuit breaker;
(ii) front vent secured inside the said assembly placed between said back vent and arc chute plates of the assembly,
   wherein said front vent comprising a substantially T-shaped profile having a substantially horizontal portion along X-axis and a substantially vertical portion along Y-axis so as to define a substantially divergent nozzle profile in the said T-shaped profile such that at the time of high fault conditions in said arc chamber nozzle effect is generated due to high pressure build up in arc chamber assembly.

According to another aspect of the present invention there is provided an improved arc chamber/chute assembly in a circuit breaker adapted for effective channelization of hot ionized gases through said arc chamber to enhance breaking capacity in circuit breakers, said assembly comprising:
a front vent secured inside the said assembly comprising a substantially T-shaped profile having a substantially horizontal portion along X-axis and a substantially vertical portion along Y-axis so as to define a substantially divergent nozzle profile in the said T-shaped profile such that at the time of high fault conditions in said arc chamber nozzle effect is generated due to high pressure build up in arc chamber assembly.

### DETAILED DESCRIPTION OF THE INVENTION

The present invention relates to an improved arc chamber assembly with a divergent vent. This invention enhances the conventional circuit breakers breaking capacity by effective channelization of hot gases inside the arc chamber

In the present invention, hot gases are channelized effectively in the arc chamber between front vent and back vent. The geometry of front vent is such that it creates a nozzle effect on the arc and its surrounding hot gases. During short circuit, these hot gases are first channelized by this divergent front vent, cooled by the back vent and then let off in the ambient. This helps faster dielectric built up and consequently reduces total arcing time and let through energy.

The improved arc chamber/chute assembly in a circuit breaker adapted for effective channelization of hot ionized gases through said arc chamber to enhance breaking capacity in circuit breakers, the assembly comprising a back vent secured inside the arc chute assembly of a conventional circuit breaker, a front vent secured inside the said assembly placed between said back vent and arc chute plates of the assembly where the front vent comprising a substantially T-shaped profile having a substantially horizontal portion along X-axis and a substantially vertical portion along Y-axis so as to define a substantially divergent nozzle profile in the said T-shaped profile such that at the time of high fault conditions in said arc chamber nozzle effect is generated due to high pressure build up in arc chamber assembly.

The vertical portion of the front vent has plurality of perforations/holes substantially at its center to reduce the pressure built up inside said arc chamber to assist the body of the circuit breaker (cassette) to be intact.

In another embodiment the present invention describes front vent with a tapered profile. The front vent comprises successive steps which can be present in any numbers depending upon the breaking capacity of the circuit breaker.

The back vent has plurality of perforations/holes throughout the back vent adapted to cool the hot gas and release the gas in the ambient.

The plurality of perforations/holes in said front and back vents are further utilized to release gases for avoidance of turbulence and vortices/swirls formation during short circuit conditions.

The front vent is having dimensions (X-axis, Y-axis) which is varied in accordance to the value of quenching current, value of the system voltage and the value of the breaker rating

The novel features of the device of the invention in which protection is sought are,
Efficient channelization of hot gases reduces ‘let through energy’ of the circuit breaker & hence reduces stresses on the electric system in line.
Unique venting arrangement channelizes the gases such that significant cooling takes place.
Depending upon the current to be quenched and the system voltage, a pattern of holes on the limb of the vents helps in release of the gases partly to avoid turbulence and vortices formation. The pattern and number of holes depends upon the breaker rating and the current to be quenched for a given voltage application.

### BRIEF DESCRIPTION OF THE ACCOMPANYING DRAWINGS

FIG. 1 illustrates RHS view of MCCB

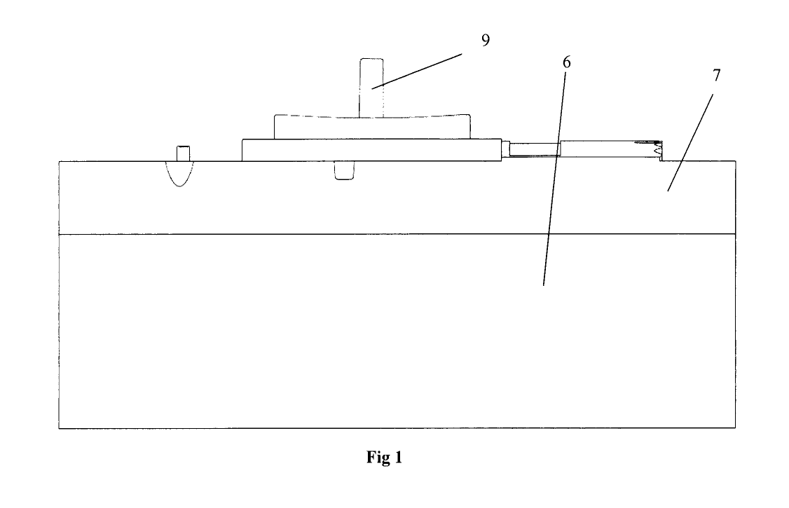

FIG. 2 illustrates Front view of MCCB

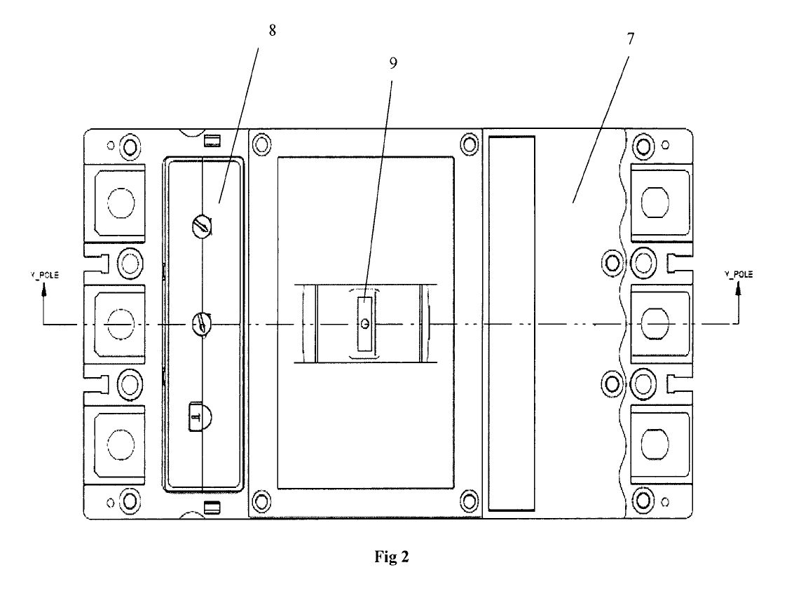

FIG. 3 illustrates Front view of MCCB without cover

FIG. 4 illustrates Sectional view of MCCB (Y pole)

FIG. 5 illustrates Sectional view of MCCB (Vent)

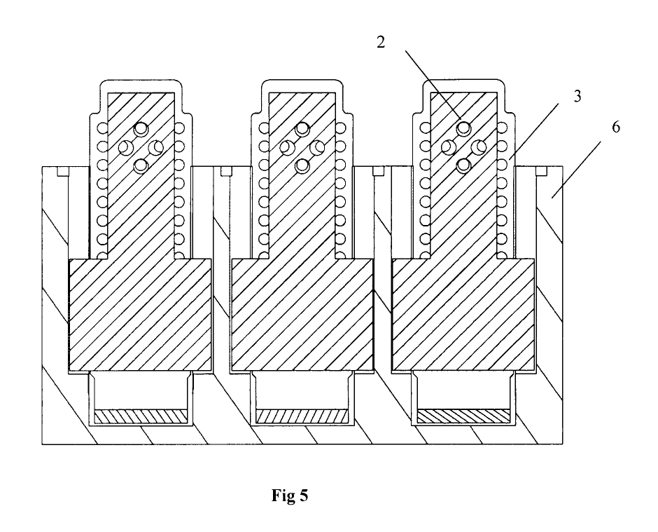

FIG. 6 illustrates Front and side view of front divergent vent (with 4 holes)

FIG. 7 illustrates Front and side view of front divergent vent (with 6 holes)

FIG. 8 illustrates Front and side view of front divergent vent (without holes)

FIG. 9 illustrates a composite arc chamber assembly with divergent T vent

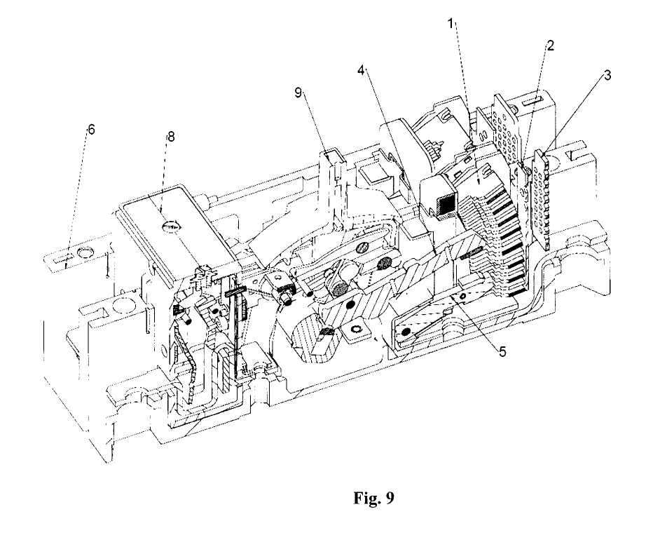

FIG. 10 illustrates a composite arc chamber assembly with divergent T vent (exploded view)

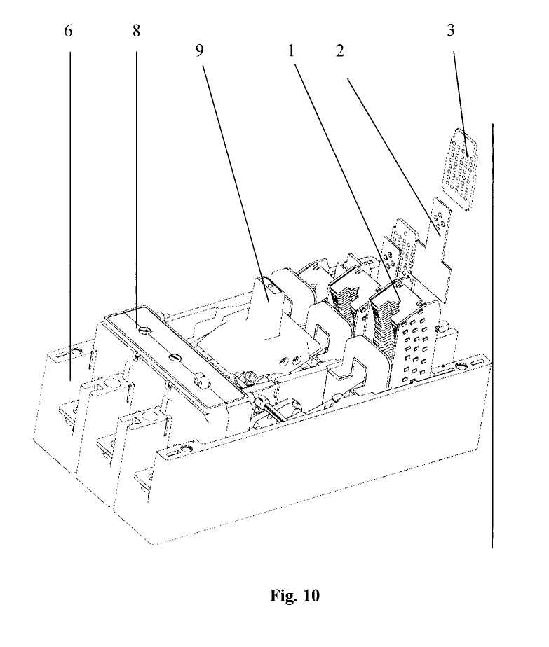

FIG. 11 illustrates front view of front divergent vent having successive steps.

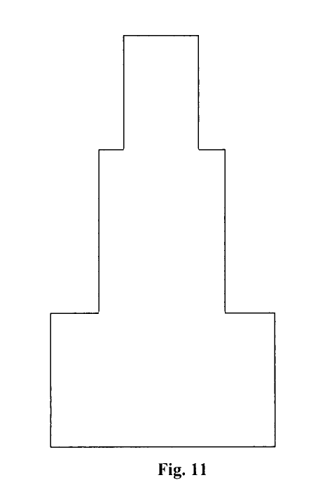

FIG. 12 illustrates front view of front divergent vent having a tapered profile.

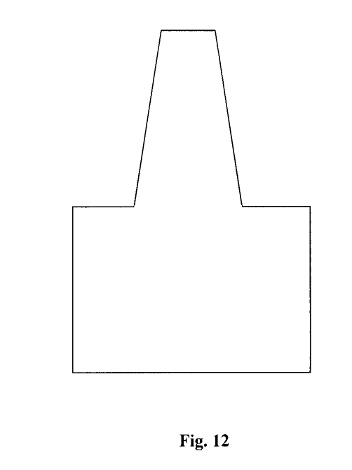

### DETAILED DESCRIPTION OF THE ACCOMPANYING DRAWINGS

### List of Components

1. Arc chute/chamber assembly

2. Front divergent vent

3. Back vent

4. Upper contact assembly

5. Lower contact assembly

6. Housing

7. Cover

8. Release assembly

9. Knob

10. Holes/Perforations

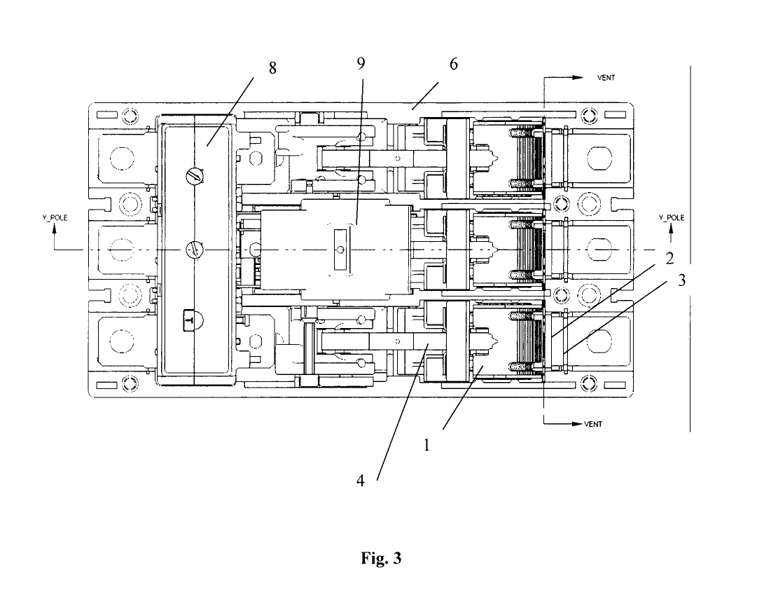

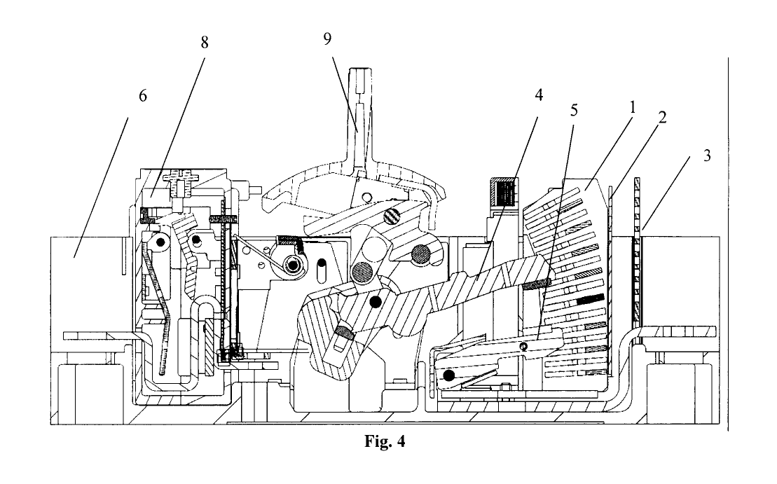

Referring to FIGS. 3 and 4 the composite arc chamber assembly (1) with front divergent vent (2) and back vent (3). The prime feature of present invention is the way hot ionized gases are channelized by this divergent vent.

### Construction of Divergent T Vent:

The front divergent type vent (2) has a characteristic shape (inverted ‘T’ shape). This creates a nozzle effect at the time of high fault current during short circuit conditions. The vent is located immediately after the arc chamber assembly.

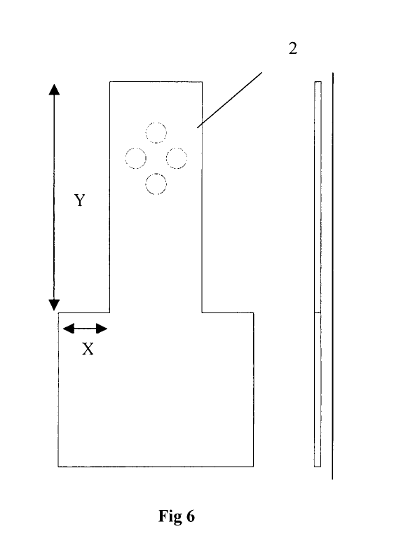

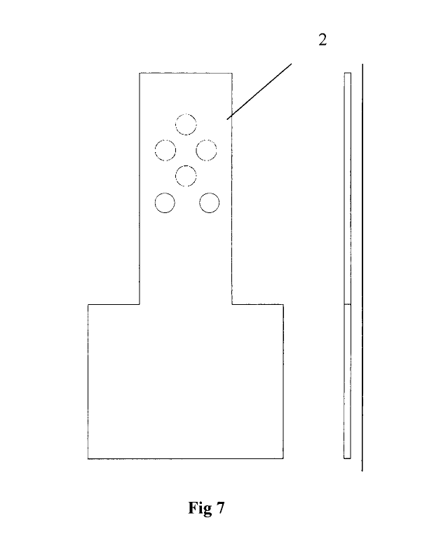

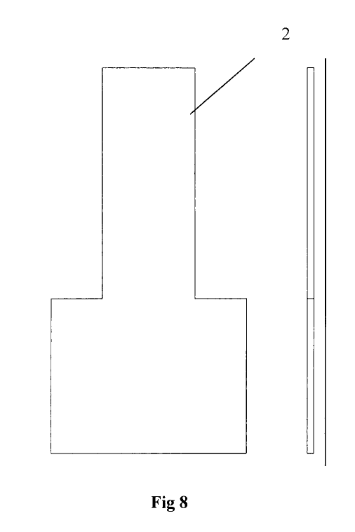

The rectangular shape provided in the vent can be varied depending upon the level of short circuit conditions. Dimensions ‘X’ and ‘Y’ can be modified to create different vent area e.g. 6×45, 8×40 etc. as illustrated in FIG. 6. Depending upon the current to be quenched and the system voltage, a pattern of holes (10) on the limb of the vents helps in release of the gases partly to avoid turbulence and vortices formation. The pattern and number of holes depends upon the breaker rating and the current to be quenched for a given voltage application. FIG. 7 illustrates one such pattern with 6 holes (10) whereas in FIG. 8 illustrates without such holes.

The present invention consists of an arc chamber assembly followed by two vents. The front vent, under high short circuit conditions, acts as a divergent nozzle. The area below the contacts is kept closed to increase the pressure and create the nozzle effect. At the same time, once the arc has reached high velocity, it allows the hot ionized gases to escape easily through side openings.

The present invention also relates to this divergent vent along with few perforations made at the centre of vent. This may vary depending upon the construction of housing and cover. The additional holes made at the centre of divergent vent are meant to reduce the pressure built up inside the arc chamber so as not to break the cassette (body of the circuit breaker). The holes or the perforations are circular in shape. However, circular shape is not to be considered as any limitation of the present invention. The holes may be triangular, hexagonal or any other regular/irregular shape. In the present embodiments the invention has been illustrated with circular holes. The hot gases generated during short circuit conditions pass through the divergent vent path and then through perforated back vent.

The invention has been described in a preferred form only and many variations may be made in the invention which will still be comprised within its spirit. The invention is not limited to the details cited above. The pattern of perforation/holes stated above do not limit the scope of the present invention. The structure thus conceived is susceptible of numerous modifications and variations, all the details may furthermore be replaced with elements having technical equivalence. In practice the materials and dimensions may be any according to the requirements, which will still be comprised within its true spirit.

1. An improved arc chamber/chute assembly in a circuit breaker adapted for effective channelization of hot ionized gases through said arc chamber to enhance breaking capacity in circuit breakers, said assembly comprising:
(i) back vent secured inside said arc chute assembly of a conventional circuit breaker;
(ii) front vent secured inside the said assembly placed between said back vent and arc chute plates of the assembly,
wherein said front vent comprising a substantially T-shaped profile having a substantially horizontal portion along X-axis and a substantially vertical portion along Y-axis so as to define a substantially divergent nozzle profile in the said T-shaped profile such that at the time of high fault conditions in said arc chamber nozzle effect is generated due to high pressure build up in arc chamber assembly.

2. An improved arc chamber/chute assembly in a circuit breaker adapted for effective channelization of hot ionized gases through said arc chamber to enhance breaking capacity in circuit breakers, said assembly comprising:
a front vent secured inside the said assembly comprising a substantially T-shaped profile having a substantially horizontal portion along X-axis and a substantially vertical portion along Y-axis so as to define a substantially divergent nozzle profile in the said T-shaped profile such that at the time of high fault conditions in said arc chamber nozzle effect is generated due to high pressure build up in arc chamber assembly.

3. Assembly as claimed in claim 1, wherein said vertical portion of the front vent further comprises plurality of perforations/holes substantially at its center adapted to reduce the pressure built up inside said arc chamber to assist the body of said circuit breaker (cassette) to be intact.

4. Assembly as claimed in claim 1 wherein said back vent comprises plurality of perforations/holes throughout said back vent adapted to cool the hot gas and release said gas in the ambient.

5. Assembly as claimed in claim 3, wherein said holes/perforations are circular in shape.

6. Assembly as claimed in claim 3, wherein said holes/perforations are optionally triangular and/or hexagonal and/or any other regular/irregular shape.

7. Assembly as claimed in claim 1 wherein said plurality of perforations/holes in said front and back vents further adapted to release gases for avoidance of turbulence and vortices/swirls formation during short circuit conditions.

8. Assembly as claimed in claim 1, wherein said front vent having a dimension corresponding to the value of quenching current.

9. Assembly as claimed in claim 1, wherein said front vent having a dimension corresponding to the value of system voltage.

10. Assembly as claimed in claim 1, wherein said front vent having a dimension corresponding to the value of breaker rating.

11. Assembly as claimed in claim 1, wherein said front vent optionally comprises plurality of successive steps or tapered profile.

12. Assembly as claimed in claim 1, wherein said front vent is optionally without holes/perforations.

13. (canceled)
